(19) United States
(12) Patent Application Publication
(10) Pub. No.: US 2024/0162512 A1
(43) Pub. Date: May 16, 2024

(54) ENERGY STORAGE APPARATUS, AND METHOD OF CONTROLLING ENERGY STORAGE APPARATUS

(71) Applicant: GS Yuasa International Ltd., Kyoto-shi, Kyoto (JP)

(72) Inventor: Yuki IMANAKA, Kyoto (JP)

(21) Appl. No.: 18/550,191

(22) PCT Filed: Mar. 2, 2022
(86) PCT No.: PCT/JP2022/008887

§ 371 Date: Sep. 12, 2023

(30) Foreign Application Priority Data
Mar. 18, 2021 (JP) 2021-044424

(51) Int. Cl. H01M 10/44; H01M 10/42; H01M 50/569; H02J 7/00

(52) U.S. Cl. CPC H01M 10/441; H01M 10/4257; H01M 50/569; H02J 7/0016; H02J 7/0048; H02J 7/007182; H01M 2010/4271; H01M 2220/20

(57) ABSTRACT

In an energy storage apparatus 1, first reducing processing where, in a case where a voltage of any one of the energy storage cells 30A is increased or a difference in voltage between any of the energy storage cells 30A is increased so that a first condition is satisfied, the difference in a remaining electricity amount between the energy storage cells 30A is reduced; second reducing processing where the difference in remaining electricity amount between the energy storage cells 30A is reduced in a case where the second condition of reducing a difference in a remaining electricity amount between the energy storage cells 30A is satisfied during a period that the first condition is not satisfied; and decision processing where a balancer discharging electricity amount when the energy storage cell 30A is discharged by the second reducing processing is decided based on a discharging history when the energy storage cell 30A is discharged by at least the first reducing processing are performed.

### CROSS REFERENCE TO RELATED APPLICATIONS

This application is a National Stage Application, filed under 35 U.S.C. § 371, of International Application No. PCT/JP2022/008887, filed Mar. 2, 2022, which international application claims priority to and the benefit of Japanese Application No. 2021-044424, filed Mar. 18, 2021; the contents of both of which as are hereby incorporated by reference in their entirety.

### BACKGROUND

### Technical Field

The present invention relates to an energy storage apparatus, and a method of controlling the energy storage apparatus.

### Description of Related Art

In an energy storage apparatus that includes a plurality of energy storage cells such as a lithium ion secondary battery, it is known that voltages are not equal between the energy storage cells due to a difference in self discharging electricity amount between the energy storage cells. In the following description, a state where the voltages are not equal is referred to as a state where a difference in electricity amount is generated.

Therefore, conventionally, a technique has been made where difference in voltage (in other words, a difference in electricity amount) between the energy storage cells is reduced by a balancer circuit (see, Patent Document JP 6540781, for example). In general, an energy storage apparatus that includes a balancer circuit monitors voltages of respective energy storage cells, and when the voltage of any one of these energy storage cells is increased to a predetermined voltage, the energy storage apparatus is discharged by a balancer circuit so that a difference in voltage between the energy storage cells is reduced.

### BRIEF SUMMARY

There is a case where an energy storage apparatus has been left for a long period of time. For example, in the case of an energy storage apparatus mounted on a vehicle, there is a case where the energy storage apparatus has been left for a long period of time and is not charged or discharged due to parking of the vehicle for a long period of time. Conventionally, the study has not been sufficiently made with respect to a technique that can reduce a difference in electricity amount between energy storage cells that takes place when the energy storage apparatus has been left for a long period of time.

The present specification discloses a technique for reducing a difference in electricity amount between energy storage cells when an energy storage apparatus has been left.

There is provided an energy storage apparatus that includes: a plurality of energy storage cells; a balancer circuit configured to allow each of the plurality of energy storage cells to individually perform discharging; and a management unit, wherein the management unit is configured to perform: first reducing processing where a difference in electricity amount between the energy storage cells is reduced by allowing at least one energy storage cell to perform discharging by the balancer circuit in a case where a voltage of any one of the energy storage cells is increased or a difference in voltage between any of the energy storage cells is increased so that a first condition of reducing the difference in the electricity amount between the energy storage cells is satisfied; determination processing where it is determined whether a second condition of reducing the difference in the electricity amount between the energy storage cells is satisfied during a time period that the first condition is not satisfied; second reducing processing where the difference in electricity amount between the energy storage cells is reduced by allowing at least one of the energy storage cells to perform discharging by the balancer circuit in a case where the second condition is satisfied; and decision processing where a discharging electricity amount when the energy storage cell is discharged by the second reducing processing is decided based on a discharging history when the energy storage cell is discharged by at least the first reducing processing.

A difference in electricity amount between the energy storage cells can be reduced when the energy storage apparatus has been left.

### BRIEF DESCRIPTION OF THE FIGURES

FIG. 1 is a schematic view of a power supply system of a vehicle according to a first embodiment.

FIG. 2 is an exploded perspective view of an energy storage apparatus.

FIG. 3A is a plan view of an energy storage device.

FIG. 3B is a cross-sectional view taken along a line A-A illustrated in FIG. 3A.

FIG. 4 is a block diagram illustrating an electrical configuration of the energy storage apparatus.

FIG. 5 is a schematic diagram for describing the operation of a balancer circuit.

FIG. 6 is a flowchart of decision processing and second reducing processing.

FIG. 7 is a schematic diagram for describing a plateau region.

FIG. 8 is a schematic diagram for describing voltage irregularities between energy storage cells.

### DETAILED DESCRIPTION OF VARIOUS EMBODIMENTS

(Overall Configuration of Embodiments)

(1) According to one aspect of the present invention, there is provided an energy storage apparatus that includes: a plurality of energy storage cells; a balancer circuit configured to allow each of the plurality of energy storage cells to individually perform discharging; and a management unit, wherein the management unit is configured to perform: first reducing processing where a difference in electricity amount between the energy storage cells is reduced by allowing at least one energy storage cell to perform discharging by the balancer circuit in a case where a voltage of any one of the energy storage cells is increased or a difference in voltage between any of the energy storage cells is increased so that a first condition of reducing the difference in the electricity amount between the energy storage cells is satisfied; determination processing where it is determined whether a second condition of reducing the difference in the electricity amount between the energy storage cells is satisfied during a time period that the first condition is not satisfied; second reducing processing where the difference in electricity amount between the energy storage cells is reduced by allowing at least one of the energy storage cells to perform discharging by the balancer circuit in a case where the second condition is satisfied; and decision processing where a discharging electricity amount when the energy storage cell is discharged by the second reducing processing is decided based on a discharging history when the energy storage cell is discharged by at least the first reducing processing.

The “voltage of any one of the energy storage cells” may be a voltage of any one of the energy storage cells or a voltage of any plurality of the energy storage cells. The “difference in electricity amount between the energy storage cells” may be a difference in remaining electricity amount between the energy storage cells. Alternatively, assuming a difference between a full charging electricity amount (in other words, a remaining electricity amount at the time of full charging) of the energy storage cell and a present remaining electricity amount of the energy storage cell as a remaining chargeable electricity amount of the energy storage cell, the “a difference in electricity amount between the energy storage cells” may be a difference in remaining chargeable electricity amount between the energy storage cells. The difference in remaining chargeable electricity amount can also be referred to as “the difference in depth of discharge (DOD)” or “the difference in voltage of the energy storage cell corresponding to the depth of discharging of the energy storage apparatus”.

Reducing a difference in a remaining electricity amount may be referred to as “bottom alignment”, and reducing a difference in a remaining chargeable electricity amount may be referred to as “top alignment”. For example, in a case where there is a difference in a full charging electricity amount between the energy storage cells or in the case where a difference in electricity amount is reduced in a high state of charge (SOC), the difference in an electricity amount may be reduced by “top alignment”, and in a case where there is no difference in a full charging electricity amount between the energy storage cells or in a case where a difference in electricity amount is reduced in a low state of charge, a difference in electricity amount may be reduced by “bottom alignment”.

The voltage of the energy storage cell is decreased due to its self discharging even when the energy storage cell has been left. A self discharging electricity amount [Ah] of the energy storage cell differs depending on the energy storage cell. Accordingly, even when the energy storage apparatus has been left, a difference in electricity amount is generated between the energy storage cells due to a difference in a self discharging electricity amount between the energy storage cells. a difference in electricity amount generated when the energy storage apparatus has been left is not reduced by the first reducing processing described above. The reason is as follows. The energy storage cells are not charged when the energy storage apparatus has been left. Accordingly, a voltage of the energy storage cell is not increased and hence, the first condition is not satisfied whereby the first reducing processing is not performed.

By allowing the energy storage cell to perform discharging by the balancer circuit even during period where the first condition is not satisfied, a difference in electricity amount when the energy storage apparatus has been left can be reduced. However, if discharging electricity amounts of respective energy storage cells are improperly determined, there is a possibility that a difference in electricity amount is increased.

The inventors of the present application have studied the above-mentioned matter. As a result of such study, the inventors have made the following finding. In discharging the energy storage cells by the present application balancer circuit during a period where the first condition is not satisfied, by determining the discharging electricity amounts of the respective energy storage cells based on discharging histories when the energy storage cells are discharged by at least the first reducing processing, the discharging electricity amounts of the respective energy storage cells can be determined such that a difference in electricity amount between the energy storage cells is reduced.

According to the energy storage apparatus described above, the inventors have made the following finding. In reducing a difference in electricity amount between the energy storage cells during the period where the first condition is not satisfied, the discharging electricity amounts of the respective energy storage cells are determined based on discharging histories when the energy storage cells are discharged by at least the first reducing processing. Accordingly, the discharging electricity amounts of the respective energy storage cells can be determined such that a difference in electricity amount between the energy storage cells is reduced. According to the energy storage apparatus described above, a difference in electricity amount between the energy storage cells when the energy storage apparatus has been left can be reduced.

(2) According to one aspect of the present invention, the management unit is configured to perform prediction processing of predicting an arrival time until a difference in electricity amount between the energy storage cell having a maximum electricity amount and the energy storage cell having a minimum electricity amount reaches a predetermined value from a point of time that the energy storage cell is previously discharged by the balancer circuit based on the discharging history, and the second condition may be a condition that the arrival time has elapsed from a point of time that the energy storage cell is previously discharged by the balancer circuit.

The above “a point of time that the energy storage cell is previously discharged by the balancer circuit” can be referred to as “a point of time that a difference in electricity amount between the energy storage cells is previously reduced by the balancer circuit”.

According to the energy storage apparatus described above, the energy storage cell is discharged when it is predicted that a difference in electricity amount of the energy storage cell having the maximum electricity amount and the electricity amount of the energy storage cell having the minimum electricity amount reaches the predetermined value. Accordingly, a difference in an electricity amount between the energy storage cells when the energy storage apparatus has been left can be suppressed to a predetermined value or less.

The above-described “a point of time that the energy storage cell is previously discharged by the balancer circuit” may be “a point of time that the energy storage cells are previously discharged by the first reducing processing”, and may include both “a point of time that the energy storage cells are previously discharged by the first reducing processing” and “a point of time that the energy storage cells are previously discharged by the second reducing processing”. By also including “a point of time that the energy storage cells are previously discharged by the second reducing processing”, compared to only “a point of time that the energy storage cells are previously discharged by the first reducing processing”, the number of discharging histories is increased and hence, the arrival time can be predicted more accurately.

(3) According to one aspect of the present invention, the management unit, in the decision processing, may obtain a total value of discharging electricity amounts for each of predetermined time periods based on the discharging history for each of the energy storage cells, the total value of the discharge electricity amounts during the predetermined time period where a point of time at which the discharging is performed is newer is given larger weighting and the total values are averaged, thus obtaining weighting average of the total values of the discharge electricity amounts for each of the predetermined time periods, and discharging electricity amounts of the respective energy storage cells that are discharged by the second reducing processing may be decided based on the weighting average of the total values of the discharge electricity amounts of the respective energy storage cells.

The self discharging electricity amount of the energy storage cell changes depending on a state (a temperature, a voltage or the like) of the energy storage cell. Accordingly, there may be a case where a total value of discharging electricity amounts for each predetermined time period largely changes.

According to the energy storage apparatus described above, the total value of the discharging electricity amounts for each predetermined time period where a point of time at which the discharging is performed is newer is given larger weighting. Accordingly, the latest state of the energy storage cells can be reflected by the determination of the discharging electricity amounts.

(4) According to one aspect of the present invention, the second condition may be a condition that an elapsed time period from a point of time that the energy storage cell is previously discharged by the balancer circuit reaches a predetermined time period.

According to the energy storage apparatus described above, the energy storage cell is discharged when the predetermined time period has elapsed from a point of time that the energy storage cell is previously discharged by the balancer circuit. As a result, a difference in an electricity amount between the energy storage cells when the energy storage apparatus has been left can be reduced.

In the energy storage apparatus described above, the arrival time until a difference in an electricity amount reaches the predetermined value from the discharging history is not predicted based on the discharging history. Accordingly, the processing can be simplified as compared with the case where the arrival time is predicted from the discharging history.

(5) According to one aspect of the present invention, the management unit may perform estimation processing of sequentially estimating an electricity amount of each of the energy storage cells based on the discharging history, and the second condition may be a condition that a difference between a maximum electricity amount and a minimum electricity amount with respect to the electricity amount of each of the energy storage cells estimated by the estimation processing reaches a predetermined value.

According to the energy storage apparatus described above, a difference in an electricity amount between the energy storage cells when the energy storage apparatus has been left can be suppressed to a predetermined value or less.

(6) According to one aspect of the present invention, the energy storage cell may have a plateau region where a change in voltage with respect to a change in a state of charge is small.

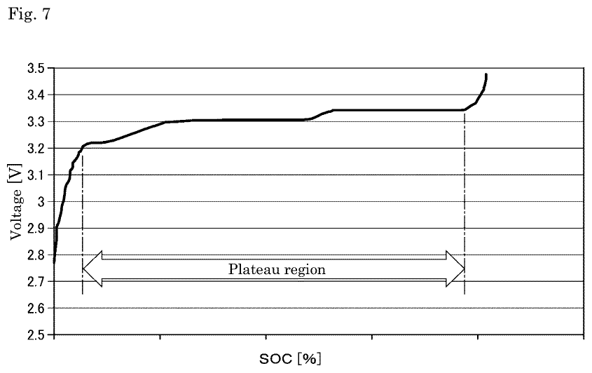

As illustrated in FIG. 7, among the energy storage cells, there are some energy storage cells each having a plateau region where a change in an open circuit voltage (OCV) of the energy storage cell with respect to a change in a state of charge (SOC) is small. The plateau region is, more specifically, for example, a region where a change amount of OCV with respect to a change amount of SOC is equal to or less than 2 [mV/%]. As an example of the energy storage cell having the plateau region, for example, a LFP/Gr-based (so-called iron based) lithium ion secondary battery that contains LiFePO₄ (lithium iron phosphate) as a positive active material and Gr (graphite) as a negative active material is exemplified.

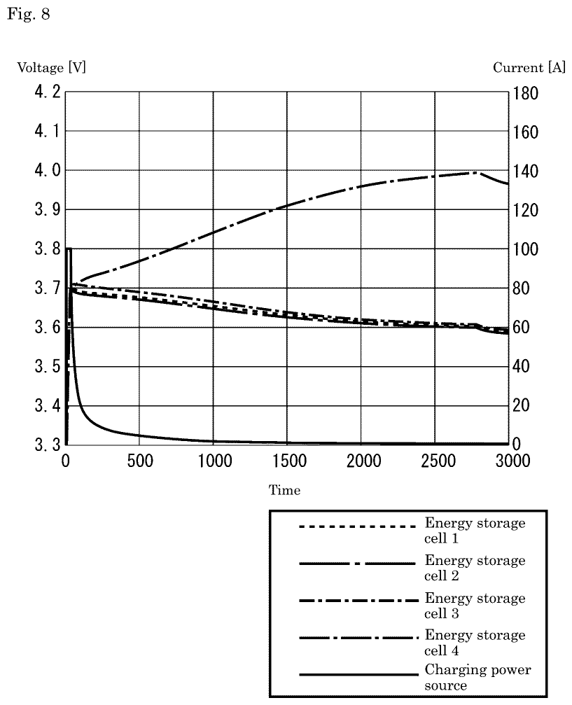

As illustrated in FIG. 8, in the energy storage cell having the plateau region, in a state where the SOC is in the plateau region, a voltage is less likely to be increased even when the charging progresses. Accordingly, an electricity amount of each energy storage cell can be accurately measured only when the energy storage cell is charged to a high SOC region (in other words, when a remaining electricity amount is large). However, when the energy storage cell has been left, the energy storage cell is not charged up to a high SOC region. Accordingly, a difference in an electricity amount cannot be accurately measured and hence, it is difficult to detect the occurrence of a difference in an electricity amount.

According to the energy storage apparatus described above, the discharging electricity amounts of the respective energy storage cells are determined based on discharging histories when the energy storage cells are discharged by at least the first reducing processing. Accordingly, the discharging electricity amounts of the respective energy storage cells can be determined such that a difference in an electricity amount between the energy storage cells is reduced even when the voltages are not measured. Accordingly, it is particularly useful in the case of an energy storage apparatus having a plateau region (in other words, an energy storage apparatus where it is difficult to accurately detect a difference in an electricity amount during the energy storage apparatus has been left).

(7) According to one aspect of the present invention, the management unit may perform the second reducing processing when the second condition is satisfied and the voltage of at least one of the energy storage cells is in the plateau region.

When the voltages of all energy storage cells are in a non-plateau region (a steep region), the voltages of the energy storage cells can be accurately measured to some extent. In this case, the discharging electricity amounts of electricity of the respective energy storage cells can be determined by measuring the voltages of the respective energy storage cells and by obtaining a difference in an electricity amount between the energy storage cells. On the other hand, when the voltage of at least one energy storage cell is in the plateau region, it is difficult to accurately obtain the difference in electricity amount.

According to the energy storage apparatus described above, the second reducing processing is performed when the second condition is satisfied and the voltage of at least one energy storage cell is in the plateau region. Accordingly, it is possible to reduce the difference in an electricity amount between the energy storage cells when the voltage of at least one energy storage cell is in the plateau region.

The invention disclosed in the present specification can be implemented in various aspects such as an apparatus, a method, a computer program for implementing the functions of the apparatus or the method, and a recording medium recording the computer program.

### Embodiment 1

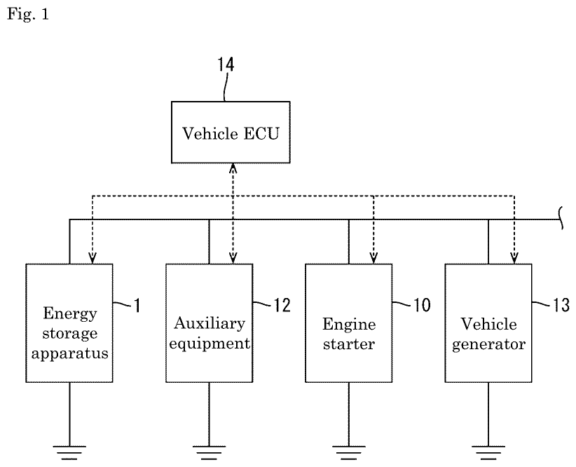

A first embodiment will be described with reference to FIG. 1 to FIG. 6. In the description made hereinafter, with respect to the same constituent elements, there are cases where reference numerals used in the drawings are omitted except for some constituent elements.

(1) Energy Storage Apparatus

An energy storage apparatus 1 according to the first embodiment is described with reference to FIG. 1. The energy storage apparatus 1 is a type of energy storage apparatus that is mounted on a vehicle such as an automobile, and is communicably connected with a vehicle engine control unit (ECU) 14. The energy storage apparatus 1 supplies electric power to an engine starter 10 (a cell motor) and auxiliary equipment 12 (a power steering, a brake, a headlight, an air conditioner, a car navigation and the like) provided to the vehicle. The energy storage apparatus 1 is charged with electric power supplied from a vehicle generator 13 (an alternator).

(2) Description of Configuration of Energy Storage Apparatus

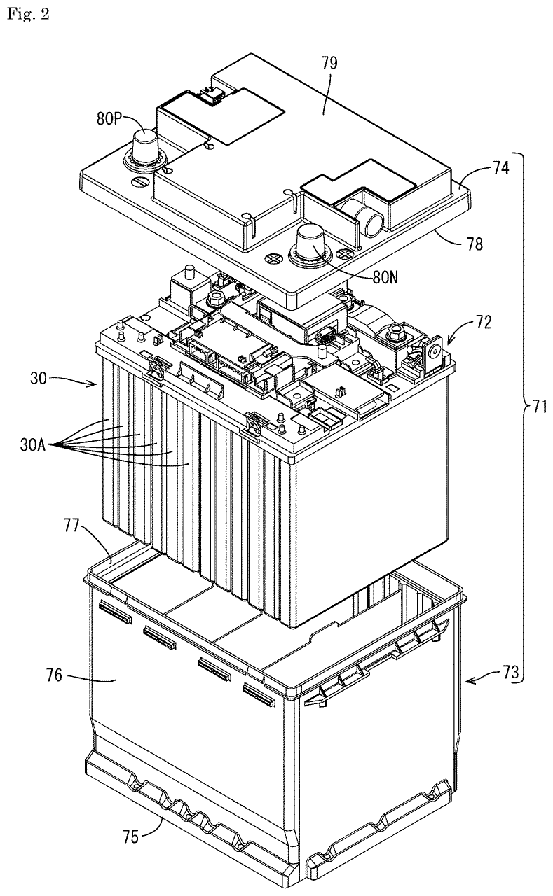

As illustrated in FIG. 2, the energy storage apparatus 1 includes a container 71. The container 71 includes a body 73 and a lid body 74 both made of a synthetic resin material. The body 73 has a bottomed cylindrical shape. The body 73 includes a bottom surface portion 75 and four side surface portions 76. An upper opening portion 77 is formed at an upper end portion of the body 73 by four side surface portions 76.

The container 71 houses an assembled battery 30 including a plurality of energy storage cells 30A and a circuit board unit 72. The circuit board unit 72 is disposed above the assembled battery 30.

A lid body 74 closes an upper opening portion 77 of the body 73. An outer peripheral wall 78 is formed on a periphery of the lid body 74. The lid body 74 has a protruding portion 79 having substantially a T-shape as viewed in a plan view. An external terminal 80P of a positive electrode is fixed to one corner portion of a front portion of the lid body 74, and an external terminal 80N of a negative electrode is fixed to the other corner portion of the front portion of the lid body 74.

The energy storage cell 30A is a secondary battery that can be repeatedly charged and discharged. More specifically, the energy storage cell 30A is a lithium ion secondary battery. Still more specifically, the energy storage cell 30A is a lithium ion secondary battery having a plateau region where a change in OCV with respect to a change in SOC is small. As an example of the lithium ion secondary battery having a plateau region, an iron-based lithium ion secondary battery where iron is contained in a positive active material is exemplified. As an example of the iron-based lithium ion secondary battery, a LFP/Gr-based lithium ion secondary battery that contains LiFePO₄ (lithium iron phosphate) as a positive active material and Gr (graphite) as a negative active material is exemplified.

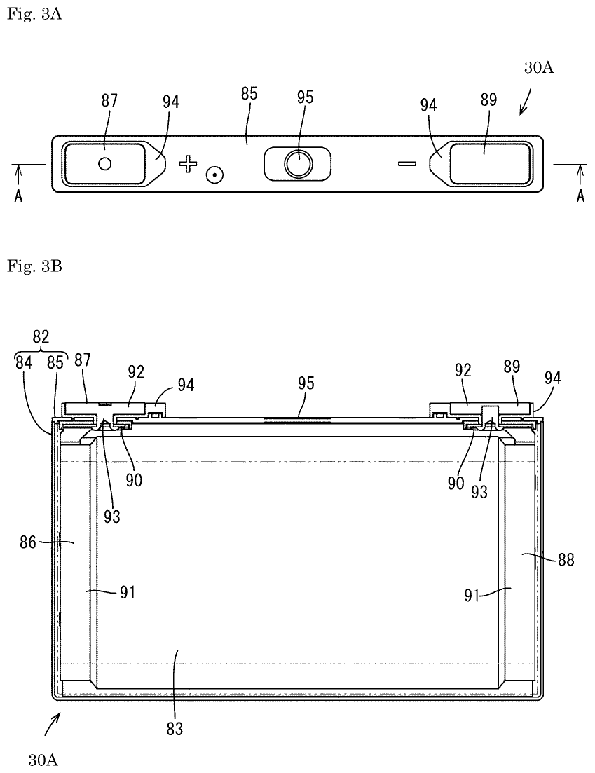

As illustrated in FIG. 3A and FIG. 3B, the energy storage cell 30A is configured such that an electrode assembly 83 is accommodated in a case 82 having a rectangular parallelepiped shape together with a nonaqueous electrolyte. The case 82 includes: a case body 84; and a lid 85 that closes an opening portion formed in an upper portion of the case body 84.

Although not illustrated in the drawings in detail, the electrode assembly 83 is formed such that a separator formed of a porous resin film is disposed between a negative electrode element that is formed by applying a negative active material to a base member formed of a copper foil and a positive electrode element that is formed by applying a positive active material to a base member formed of an aluminum foil. These elements all have a strip shape, and are wound in a flat shape so as to be accommodated in the case body 84 in a state where the position of the negative electrode element and the position of the positive electrode element are displaced toward opposite sides in the width direction with respect to the separator.

A positive electrode terminal 87 is connected to the positive electrode element via a positive electrode current collector 86, and a negative electrode terminal 89 is connected to the negative electrode element via a negative electrode current collector 88. The positive electrode current collector 86 and the negative electrode current collector 88 are each formed of a flat-plate-like pedestal portion 90 and a leg portion 91 extending from the pedestal portion 90. A through hole is formed in the pedestal portion 90. The leg portion 91 is connected to the positive electrode element or the negative electrode element. The positive electrode terminal 87 and the negative electrode terminal 89 each include: a terminal body portion 92; and a shaft portion 93 protruding downward from a center portion of a lower surface of the terminal body portion 92. In such a configuration, the terminal body portion 92 and the shaft portion 93 of the positive electrode terminal 87 are integrally formed with each other using aluminum (a single material). In the negative electrode terminal 89, the terminal body portion 92 is made of aluminum, and the shaft portion 93 is made of copper. The negative electrode terminal 89 is formed by assembling the terminal body portion 92 and the shaft portion 93 to each other. The terminal body portion 92 of the positive electrode terminal 87 and the terminal body portion 92 of the negative electrode terminal 89 are disposed at both end portions of the lid 85 via gaskets 94 made of an insulating material. The terminal body portion 92 of the positive electrode terminal 87 and the terminal body portion 92 of the negative electrode terminal 89 are exposed outward from the gaskets 94.

As illustrated in FIG. 3A, the lid 85 has a pressure release valve 95. The pressure release valve 95 is positioned between the positive electrode terminal 87 and the negative electrode terminal 89. The pressure release valve 95 is released when an internal pressure in the case 82 exceeds a limit value so as to lower the internal pressure in the case 82.

(3) Description of Electric Configuration of Energy Storage Apparatus

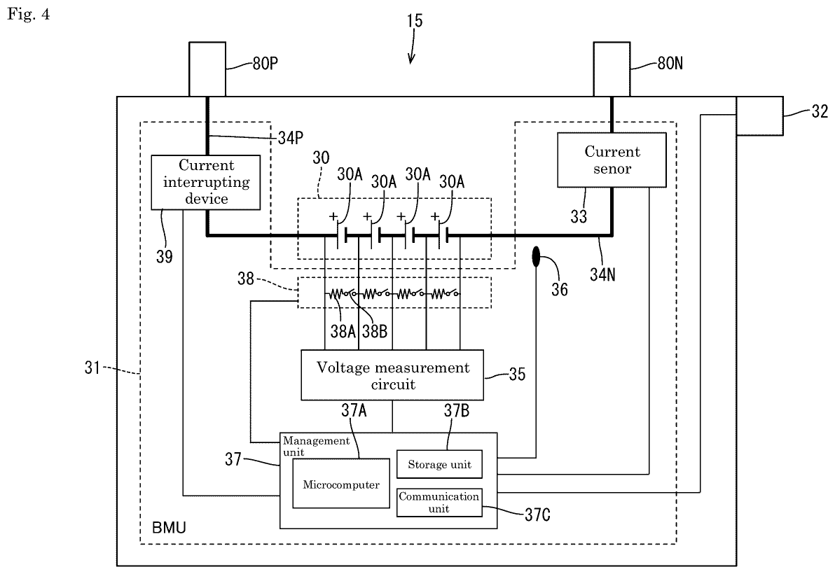

As illustrated in FIG. 4, the energy storage apparatus 1 includes the assembled battery 30, a BMU 31 (an example of a management device), and a communication connector 32. The assembled battery 30 is connected to the external terminal 80P of the positive electrode by a power line 34P, and is connected to the external terminal 80N of the negative electrode by a power line 34N.

The assembled battery 30 is formed by connecting twelve energy storage cells 30A to each other in three parallels and four series. In FIG. 4, three energy storage cells 30A that are connected in parallel are indicated by one battery symbol.

The BMU 31 includes a current sensor 33, a voltage measurement circuit 35, a temperature sensor 36, a balancer circuit 38, a current interrupting device 39, and a management unit 37.

The current sensor 33 is positioned on a negative electrode side of the assembled battery 30, and is disposed on the power line 34N of a negative electrode. The current sensor 33 measures a charging/discharging current [A] of the assembled battery 30 and outputs the measured charging/discharging current to the management unit 37.

The voltage measurement circuit 35 is connected to both ends of each of the energy storage cells 30A by signal lines. The voltage measurement circuit 35 measures battery voltages [V] of the respective energy storage cells 30A and outputs the measured battery voltages [V] to the management unit 37. A total voltage [V] of the assembled battery 30 is a sum of voltages of four energy storage cells 30A connected in series.

The temperature sensor 36 is a contact type sensor or a non-contact type sensor. The temperature sensor 36 measures temperatures [° C.] of the energy storage cells 30A, and outputs the measured temperatures to the management unit 37. Although not illustrated in FIG. 4, two or more temperature sensors 36 are provided. The respective temperature sensors 36 measure temperatures of the respectively different energy storage cells 30A.

The balancer circuit 38 is a passive balancer circuit 38 that reduces a difference in a remaining electricity amount between the respective energy storage cells 30A by discharging the energy storage cell 30A having a relatively high voltage among the respective energy storage cells 30A. The balancer circuit 38 includes a discharge resistor 38A and a switch element 38B for each energy storage cell 30A. The discharge resistor 38A and the switch element 38B are connected in series, and are connected in parallel with the corresponding energy storage cell 30A. The switch element 38B is switched between an electricity supply state (a closed state, an ON state, a close state) and an interruption state (an opened state, an off state, an open state) by the management unit 37. When the switch element 38B is brought into an electricity supply state, electricity of the energy storage cell 30A corresponding to the switch element 38B is discharged by the discharge resistor 38A.

The current interrupting device 39 is provided to the power line 34 P. As the current interrupting device 39, a contact switch (a mechanical type switch) such as a relay, a semiconductor switch such as a field effect transistor (FET) or the like can be used. The current interrupting device 39 is switched between an electricity supply state and an electricity interruption state by the management unit 37.

The management unit 37 includes: a microcomputer 37A where a CPU, a RAM, and the like are integrated into one chip; a storage unit 37B; and a communication unit 37C. The storage unit 37B is a storage medium capable of rewriting data, and stores various programs, data, and the like. The microcomputer 37A manages the energy storage apparatus 1 by performing a program stored in the storage unit 37B. The communication unit 37C is a circuit that allows the BMU 31 to communicate with the vehicle ECU14.

The communication connector 32 is a connector to which a communication cable that allows the BMU 31 to communicate with the vehicle ECU14 is connected.

(4) Processing Performed by Management Unit

The following four processing performed by the management unit 37 are described.
first reducing processing
recording processing
decision processing
second reducing processing

(4-1) First Reducing Processing

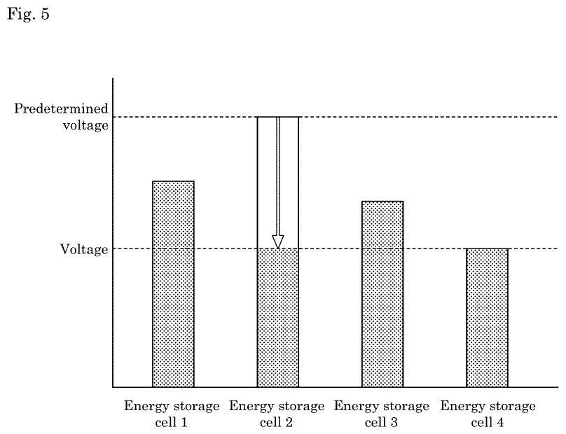

As illustrated in FIG. 5, with respect to the energy storage apparatus 1, there may be a case where a difference in remaining electricity amount occurs between the energy storage cells 30A due to irregularities in a self discharging electricity amount between the respective energy storage cells 30A. For the sake of convenience, in FIG. 5, four energy storage cells 30A are given with reference symbols of 1 to 4. The first reducing processing is processing of reducing a difference in remaining electricity amount between the energy storage cells 30A.

Specifically, when the voltage of any one of the energy storage cells 30A is increased to a predetermined voltage, the management unit 37 controls the balancer circuit 38 so as to discharge the energy storage cell 30A such that the voltage of the energy storage cell 30A becomes substantially equal to the voltage of the energy storage cell 30A having the lowest voltage among other energy storage cells 30A. As a result, the difference in remaining electricity amount between the energy storage cells 30A is reduced.

To increase the voltage of any one of the energy storage cell 30A to a predetermined voltage is one example of the first condition. The first condition may be a condition that the voltages of any two or more energy storage cells 30A are increased to a predetermined voltage.

Here, when the voltage of the energy storage cell 30A having the lowest voltage is in the plateau region, there is a possibility that the electricity amount of the energy storage cell 30A having the lowest voltage cannot be accurately measured. Accordingly, thus it is difficult to accurately determine whether or not a difference in a remaining electricity amount between the energy storage cell 30A has been reduced. However, in a case where the difference in the remaining electricity amount has been left, the first reducing processing is performed again when the energy storage cell 30A is again charged. Accordingly, the first reducing processing is repeated many times and hence, the remaining electricity amounts become equal or leveled soon or later.

(4-2) Recording Processing

The recording processing is processing of, when each energy storage cell 30A is discharged by the first reducing processing, recording a discharged electricity amount (hereinafter, referred to as a balancer discharging electricity amount [Ah]) in the storage unit 37B as a balancer discharging history (an example of a discharging history).

Specifically, when the management unit 37 makes the balancer circuit 38 discharge the energy storage cell 30A, the management unit 37 measures a discharged electricity amount (balancer discharging electricity amount). When the management unit 37 makes a certain energy storage cell 30A perform discharging, the management unit 37 measures a voltage of the energy storage cell 30A by the voltage measurement circuit 35. The management unit 37 measures a balancer discharging electricity amount in such a manner that the management unit 37 calculates and integrates for each predetermined time period, the current discharged by the balancer circuit 38 in accordance with Ohm's law based on the voltage of energy storage cell 30A and the resistance value of the discharge resistor 38A that corresponds to the energy storage cell 30A. The management unit 37 records the measured balancer discharging electricity amount and the measured point of time in the storage unit 37B in association with the discharged energy storage cell 30A.

The balancer discharging electricity amount during the predetermined period is equivalent to the cell self discharging electricity amount during the predetermined period. The cell self discharging electricity amount can be estimated based on the history of the balancer discharging electricity amount.

(4-3) Decision Processing

The state where the energy storage apparatus 1 has been left is a state where a vehicle on which the energy storage apparatus 1 is mounted is parked for a long time period, or a state where a traveling time period of the vehicle is extremely short compared to a parking time period and the energy storage apparatus 1 has not been fully charged for a long time period. The energy storage cell 30A has been charged by the vehicle generator 13 before the vehicle is parked. Accordingly, in a case where the energy storage apparatus 1 has been left, a balancer discharging history of first reducing processing performed before the energy storage apparatus 1 has been left is recorded in the storage unit 37B.

In a case where the energy storage apparatus 1 has been left, a voltage is increased to a predetermined voltage (a voltage at which the first reducing processing is performed) with respect to none of energy storage cells 30A. The management unit 37 determines whether or not the second condition for reducing a difference in remaining electricity amount between the energy storage cells 30A is satisfied during the period where the voltages of all energy storage cells 30A are less than the predetermined voltage (in other words, the period where the energy storage apparatus 1 has been left) (an example of the determination processing). Details of the second condition will be described later. When the management unit 37 determines that the second condition is satisfied, the management unit 37 reduces a difference in remaining electricity amount between the energy storage cells 30A by second reducing processing described later.

The decision processing is processing where a balancer discharging electricity amount discharged by the second reducing processing described later is decided based on a balancer discharging history for each energy storage cell 30A. Hereinafter, the second condition and determination of the balancer discharging electricity amount for each energy storage cell 30A will be described.

(4-3-1) Second Condition

The second condition is a condition that an arrival time described next has elapsed from a point of time that the energy storage cells 30A are previously discharged by the balancer circuit 38. Here, “a point of time that the energy storage cells 30A are previously discharged by the balancer circuit 38” means a point of time that the first reducing processing is previously performed in a case where the second reducing processing described later is not performed after the first reducing processing is previously performed. In a case where the second reducing processing described later is performed after the first reducing processing is previously performed, “a point of time that the energy storage cells 30A are previously discharged by the balancer circuit 38” means a point of time that the second reducing processing is previously performed.

The arrival time is described with reference to a following Table 1. Table 1 shows a total value of a balancer discharging electricity amounts discharged by the first reducing processing in the latest 10,000 hours for each energy storage cell 30A. For the sake of convenience, in Table 1, four energy storage cells 30A are given with reference symbols of 1 to 4.

TABLE 1

| | Energy | Energy | Energy | Energy |
|---|---|---|---|---|
| | storage | storage | storage | storage |
| | cell 1 | cell 2 | cell 3 | cell 4 |
| Balancer discharging | 105 mAh | 120 mAh | 80 mAh | 70 mAh |
| electricity amount | | | | |
| discharged in latest | | | | |
| 10,000 hours | | | | |
| Balancer discharging | 3.5 mAh | 5 mAh | 1 mAh | (Reference |
| electricity amount | | | | cell) |
| necessary at a point | | | | |
| of time after 1,000 | | | | |
| hours have elapsed | | | | |

The arrival time is a predicted time that a difference in remaining electricity amount between the energy storage cell 30A having the maximum remaining electricity amount and the energy storage cell 30A having the minimum remaining electricity amount reaches a predetermined maximum allowable value (an example of a predetermined value) as counted from a point of time that the energy storage cell 30A is previously discharged by the balancer circuit 38. The “a point of time that the energy storage cell 30A is previously discharged by the balancer circuit 38” may be “a point of time that the energy storage cell 30A is previously discharged by the first reducing processing” or may include both “a point of time that the energy storage cell 30A is previously discharged by the first reducing processing” and “a point of time that the energy storage cell 30A is previously discharged by the second reducing processing described later”.

The management unit 37 predicts the arrival time described above based on the balancer discharging history (an example of prediction processing). Specifically, in the example indicated in Table 1, the energy storage cell 30A having the maximum balancer discharging electricity amount after 10,000 hours have elapsed is the energy storage cell 2, and the energy storage cell 30A having the minimum balancer discharging electricity amount is the energy storage cell 4. The energy storage cell 2 is discharged 50 mAh (=120 mAh−70 mAh) more per 10,000 hours than energy storage cell 4. Accordingly it can be estimated that a difference in remaining electricity amount of 50 mAh per 10,000 hours will occur between energy storage cell 2 and the energy storage cell 4.

Assuming that the predetermined maximum allowable value is 5 mAh, 5 mAh is 1/10 of 50 mAh (=5 mAh/50 mAh). Accordingly, it is predicted that the arrival time until a difference in remaining electricity amount between the energy storage cell 30A having the maximum remaining electricity amount and the energy storage cell 30A having the minimum remaining electricity amount reaches a predetermined maximum allowable value (5 mAh) as counted from a point of time that the energy storage cell 30A is discharged by the balancer circuit 38 is 1000 hours that is 1/10 of 10000 hours. Accordingly, the management unit 37 predicts the arrival time by the following Expression 1.

Arrival time=10,000 hours/(50 mAh/5 mAh)=1000 hours Expression 1

(4-3-2) Determination of Balancer Discharging Electricity Amount for Each Energy Storage Cell

The management unit 37 predicts a balancer discharging electricity amount of each energy storage cell 30A at a point of time that the above-mentioned arrival time (1000 hours in this case) has elapsed based on the balancer discharging history. In the example indicated in Table 1, the balancer discharging electricity amounts of the respective energy storage cells 30A at a point of time that 1000 hours have elapsed are predicted as follows.
energy storage cell 1=105 mAh/10
energy storage cell 2=120 mAh/10
energy storage cell 3=80 mAh/10
energy storage cell 4=70 mAh/10

The management unit 37, using the energy storage cell 30A having the smallest predicted balancer discharging electricity amount at a point of time that 1000 hours have elapsed among the respective energy storage cells 30A as a reference, determines a difference between the predicted balancer discharging electricity amount of the energy storage cell 30A having the smallest predicted balancer discharging electricity amount and the predicted balancer discharging electricity amount of another energy storage cell 30A as a balancer discharging electricity amount required by another energy storage cell 30A at a point of time that 1000 hours have elapsed.

Specifically, in the example illustrated in Table 1, the energy storage cell 30A having the smallest predicted balancer discharging electricity amount is the energy storage cell 4. In this case, the required balancer discharging electricity amount of the other energy storage cells 1 to 3 at the time point when 1000 hours have elapsed is determined as follows.
energy storage cell 1=(105 mAh−70 mAh)/10=3.5 mAh
energy storage cell 2=(120 mAh−70 mAh)/10=5 mAh
energy storage cell 3=(80 mAh−70 mAh)/10=1 mAh
energy storage cell 4 (refence cell)=0 mAh

(4-4) Second Reducing Processing

The second reducing processing is processing of making the respective energy storage cells 30A discharge balancer discharging electricity amounts that are decided by the above-mentioned decision processing by controlling the balancer circuit 38.

The management unit 37 may record a balancer discharging electricity amount as a balancer discharging history in a case where the respective energy storage cells 30A are discharged by the second reducing processing. In a case where the management unit 37 performs decision processing thereafter, the management unit 37 may also use the discharging history when discharging is performed by the second reducing processing in the decision of the balancer discharging electricity amount.

(5) Flowchart of Decision Processing and Second Reducing Processing

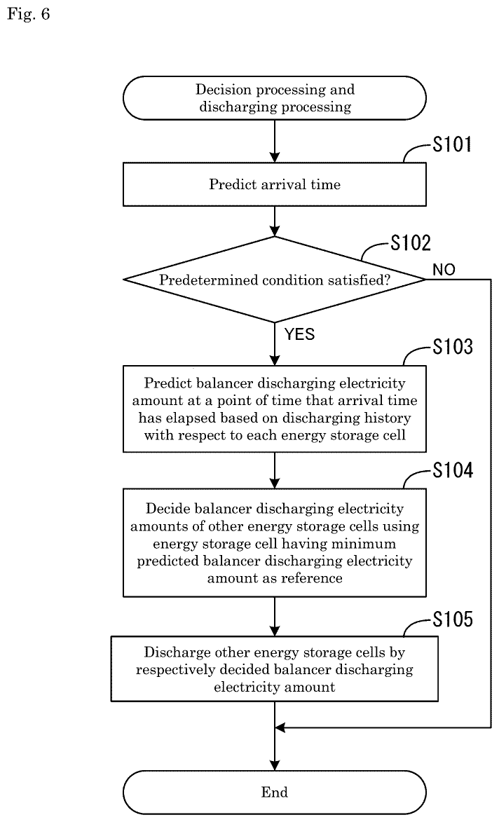

With reference to FIG. 6, a flowchart of decision processing and second reducing processing is described. In the description made hereinafter, the decision processing and the second reducing processing are referred to as main processing. The main processing is, after the first reducing processing is previously performed, repeatedly performed at a predetermined time interval (for example, a time interval of 1 hour).

In S101, the management unit 37 predicts an arrival time by performing the above-mentioned prediction processing (decision processing).

In S102, the management unit 37 determines whether or not the above-mentioned second condition (the condition that the arrival time has elapsed from a point of time that energy storage cells 30A are previously discharged by the balancer circuit 38) is satisfied (determination processing). The management unit 37 makes the processing advance to S103 when the second condition is not satisfied, and finishes the present processing when the second condition is not satisfied.

In S103, the management unit 37 predicts a balancer discharging electricity amount at a point of time that the arrival time has elapsed based on the balancer discharging history with respect to the respective energy storage cell 30A (decision processing).

In S104, the management unit 37 determines balancer discharging electricity amounts necessary for other energy storage cells 30A using the energy storage cell 30A where the predicted balancer discharging electricity amount is minimum at a point of time that the arrival time has elapsed among the respective energy storage cells 30A as a reference (decision processing).

In S105, the management unit 37 controls the balancer circuit 38 so as to make other energy storage cells 30A perform discharging by the balancer discharging electricity amounts determined respectively in step S104 by controlling the balancer circuit 38 (second reducing processing).

It is not always necessary that the above-mentioned S101, S103, and S104 are performed in the present processing. For example, in case of S101, after the first reducing processing is previously performed, the arrival time is predicted before the present processing is performed first, and the predicted arrival time may be used in the present processing. Alternatively, even in a case where S101 is performed in the present processing, it is not always necessary to perform S101 every time. Specifically, S101 is performed only when the present processing is performed first after the first reducing processing is previously performed and, thereafter, when the present processing is performed, the first predicted arrival time may be used. The same goes for S103 and S104.

(6) Advantageous Effects of Embodiment

According to the energy storage apparatus 1 of the first embodiment, in a case where a difference in remaining electricity amount of the energy storage cell 30A is reduced during a period where voltages of all energy storage cells 30A are less than a predetermined voltage (in other words, a period during which the energy storage apparatus 1 has been left), the balancer discharging electricity amounts of the respective energy storage cells 30A are determined based on the balancer discharging histories. Accordingly, the balancer discharging electricity amounts of the respective energy storage cells 30A can be determined such that a difference in the remaining electricity amount between the energy storage cells 30A is reduced. With such a configuration, according to the energy storage apparatus 1, a difference in remaining electricity amount between the energy storage cells 30A when the energy storage apparatus 1 has been left can be reduced.

According to the energy storage apparatus 1, it is estimated that a difference in remaining electricity amount between the energy storage cell 30A having the maximum remaining electricity amount and the energy storage cell 30A having the minimum remaining electricity amount reaches the maximum allowable value, the energy storage cell 30A is discharged. Accordingly, a difference in remaining electricity amount between the energy storage cells 30A when the energy storage apparatus 1 has been left can be suppressed to the maximum allowable value or less.

According to energy storage apparatus 1, the balancer discharge electricity amounts of the respective energy storage cells 30A are determined based on the balancer discharging histories when the energy storage cells 30A are discharged by first reducing processing. Accordingly, even when voltages are not measured, the balancer discharging electricity amounts of the respective energy storage cells 30A can be determined such that a difference in the remaining electricity amount between the energy storage cells 30A is reduced. Accordingly, the first embodiment is particularly useful in the case of the energy storage apparatus 1 having a plateau region (in other words, energy storage apparatus 1 where the accurate detection of a difference in voltage between a period that the energy storage apparatus 1 has been left is difficult).

### Embodiment 2

The second embodiment is a modification of the first embodiment. The management unit 37 according to the second embodiment, in the decision processing, decides the balancer discharging electricity amounts of the respective energy storage cells 30A that perform discharging by the second reducing processing in accordance with the following steps.

Step 1: The management unit 37 obtains a total value of discharge electricity amounts for each predetermined time period for each energy storage cell 30A based on the balancer discharging histories.

Step 2: The management unit 37 obtains a weighting average of a total values of the discharge electricity amounts for each predetermined time period by performing averaging such that the total value of the discharge electricity amounts for a predetermined time period having a newer point of time at which the discharging is performed has the larger weighting.

Step 3: The management unit 37 determines the balancer discharging electricity amounts of the respective energy storage cells 30A that perform discharging by the second reducing processing based on the weighting averages of the respective energy storage cells 30A.

Step 3 is specifically described with reference to Table 2. In the example illustrated in Table 2, the predetermined time period is set to 2000 hours. Table 2 indicates a result obtained by summing up the balancer discharging electricity amounts stored as the balancer discharging histories every 2000 hours with respect to the respective energy storage cells 30A.

TABLE 2

| | Energy | | Energy | | Energy | | Energy | | |
|---|---|---|---|---|---|---|---|---|---|
| | storage | | storage | | storage | | storage | | Weight- |
| | cell 1 | | cell 2 | | cell 3 | | cell 4 | | ing |
| Balancer discharging electricity | 25 | mAh | 27 | mAh | 15 | mAh | 18 | mAh | 1 |
| amount in 8000 to 10000 hours | | | | | | | | | |
| Balancer discharging electricity | 19 | mAh | 28 | mAh | 15 | mAh | 17 | mAh | 2 |
| amount in 6000 to 8000 hours | | | | | | | | | |
| Balancer discharging electricity | 18 | mAh | 30 | mAh | 17 | mAh | 16 | mAh | 3 |
| amount in 4000 to 6000 hours | | | | | | | | | |
| Balancer discharging electricity | 17 | mAh | 31 | mAh | 18 | mAh | 15 | mAh | 4 |
| amount in 2000 to 4000 hours | | | | | | | | | |
| Balancer discharging electricity | 17 | mAh | 30 | mAh | 22 | mAh | 14 | mAh | 5 |
| amount in 0 to 2000 hours | | | | | | | | | |
| Weighting average of balancer | 18 | mAh | 29.8 | mAh | 18.53 | mAh | 15.33 | mAh | — |
| discharging electricity amounts | | | | | | | | | |
| every 2000 hours | | | | | | | | | |
| Balancer discharging electricity | 1.3 | mAh | 7.2 | mAh | 1.6 | mAh | (Reference | | |
| amount necessary at a point of | | | | | | | cell) | | |
| time after lapse of 1000 hours | | | | | | | | | |

In an example illustrated in Table 2, a total value of discharging electricity amounts for a predetermined time period having the newer discharged point of time has the larger weighting. Specifically, weighting of the total value of discharging electricity amounts in 0 to 2000 hours is set to 5, weighting of the total value of discharging electricity amounts in 2000 to 4000 hours is set to 4, weighting of the total value of discharging electricity amounts in 4000 to 6000 hours is set to 3, weighting of the total value of discharging electricity amounts in 6000 to 8000 hours is set to 2, and weighting of the total value of discharging electricity amounts in 8000 to 10000 hours is set to 1.

To describe a weighting average by taking the energy storage cell 1 indicated in Table 2 as an example, the weighting average of the total values of discharging electricity amounts of the energy storage cell 1 for each predetermined time period (2000 hours) is expressed by the following Expression 2.

weighting average=(25 mAh×1+19 mAh×2+18 mAh×3+17 mAh×4+17 mAh×5)/15=18 mAh Expression 2

In the same manner, the weighting average of the total values of discharging electricity amounts of the energy storage cell 2 is 29.8 mAh, the weighting average of the total values of discharging electricity amounts of the energy storage cell 3 is 18.53 mAh, and the weighting average of the total values of discharging electricity amounts of the energy storage cell 4 is 15.33 mAh.

In this case, the energy storage cell 30A having the minimum weighting average is the energy storage cell 4. Accordingly, the management unit 37 determines the balancer discharging electricity amount necessary for the respective energy storage cells 30A at a point of time after the lapse of 1000 hours using the energy storage cell 4 as the reference. Specifically, to describe the balancer discharging electricity amount by taking the energy storage cell 1 as an example, the difference between the energy storage cell 1 and the energy storage cell 4 per 2000 hours becomes as follows. 2.67 mAh (=18 mAh−15.33 mAh) In this case, the balancer discharging electricity amount necessary for the energy storage cell 1 at t appoint of time after the lapse of time 1000 hour s is determined as follows.

discharging electricity amount=2.67 mAh×(1000/2000)=1.3 mAh

In the same manner, the balancer discharging electricity amount necessary for the energy storage cell 2 at the point of time after the lapse of 1000 hours becomes 7.2 mAh, and the balancer discharging electricity amount of the energy storage cell 3 at the point that after the lapse of 1000 hours becomes 1.6 mAh.

According to the energy storage apparatus 1 of the second embodiment, the total value for the predetermined time period having the newer discharged point of time have the larger weighting and hence, the latest state of the energy storage cell 30A can be reflected by deciding the balancer discharging electricity amount.

### Embodiment 3

The second condition according to the third embodiment is a condition that a time period elapsed from a point of time that the energy storage cells 30A are discharged by the balancer circuit 38 has reached a predetermined time period.

In the first embodiment described above, the arrival time is predicted based on the predetermined maximum allowable value, and when the arrival time has elapsed, the energy storage cells 30A are discharged. On the other hand, the predetermined time period described above can be arbitrarily determined regardless of the maximum allowable value. For example, in the case of the example illustrated in Table 1 described above, the predetermined time period may be set to 500 hours, 1500 hours, or 2000 hours.

For example, in the example illustrated in Table 1, assume that the predetermined time period is 2000 hours. Since 2000 hours is ⅕ (=2000/10000) of 10,000 hours, the balancer discharging electricity amounts of the respective energy storage cells 30A at the point of time that 2000 hours have elapsed is determined as follows.
energy storage cell 1=(105 mAh−70 mAh)/5=7 mAh
energy storage cell 2=(120 mAh−70 mAh)/5=10 mAh
energy storage cell 3=(80 mAh−70 mAh)/5=2 mAh
energy storage cell 4 (refence cell)=0 mAh

According to the energy storage apparatus 1 according to the third embodiment, the energy storage cells 30A are discharged when the predetermined time period has elapsed from a point of time that the energy storage cells 30A is previously discharged by the balancer circuit 38. As a result, a difference in a remaining electricity amount between the energy storage cells 30A when the energy storage apparatus 1 has been left can be reduced.

In the energy storage apparatus 1 according to the third embodiment, the prediction of the arrival time until a difference in an electricity amount reaches the predetermined maximum allowable value based on the discharging histories is not performed. Accordingly, the processing can be simplified as compared with the case where the arrival time is predicted based on the discharging histories.

### Other Embodiments

The technique disclosed in the present specification is not limited to the embodiments described with reference to the description and drawings described above. For example, the following embodiments are also included in the technical scope disclosed in the present specification.

(1) In the embodiment described above, the description has been made with respect to the example the first condition is the condition that the voltage of any one of the energy storage cells 30A is increased to the predetermined voltage. However, the first condition is not limited to such a condition. For example, the first condition may be a condition that a difference in voltage between any energy storage cells 30A is increased to a predetermined difference in voltage.

(2) In the embodiment described above, the case is exemplified where management unit 37 measures a balancer discharging electricity amount in such a manner that the management unit 37 calculates and integrates, for each predetermined time period, the current discharged by the balancer circuit 38 in accordance with Ohm's law based on the voltage of the energy storage cell 30A and the resistance value of the discharge resistor 38A that corresponds to the energy storage cell 30A. However, the method of measuring the balancer discharging electricity amount is not limited to such a method. For example, the management unit 37 may measure a voltage of the energy storage cell 30A by the voltage measurement circuit 35, and when the voltage of the energy storage cell 30A is decreased to the same voltage as a voltage of the energy storage cell 30A having the lowest voltage, a difference in voltage between the voltage before discharging and the voltage after discharging may be converted into a discharging electricity amount [Ah] by a predetermined calculation expression (or table).

Alternatively, a remaining electricity amount [Ah] of the energy storage cell 30A may be estimated from a voltage before discharging, a remaining electricity amount of the energy storage cell 30A may be estimated from a voltage after discharging, and a difference between these remaining electricity amounts may be used as a balancer discharging electricity amount.

Alternatively, the management unit 37 may store a resistance value of the discharge resistor 38A of the balancer circuit 38, and may integrate a discharging electricity amount by sequentially measuring a change in voltage. Specifically, a balancer discharging electricity amount may be calculated from the following Expressions 8 to 10.

balancer current I1 at point of time t1=cell voltage/discharging resistance value at point of time t1 Expression 8

balancer current I2 at point of time t2=cell voltage/discharging resistance value at point of time t2 Expression 9

balancer discharging electricity amount in section between point of time t1 and point of time t2=(I2−I1)×(t2−t1) Expression 10

Alternatively, an average value of a balancer current may be stored from a normal voltage (for example, 3.5 V) and a resistance of the discharge resistor 38A at which the balancer circuit 38 operates. Then, the management unit 37 may calculate a balancer discharging electricity amount by multiplying a balancer operation time and an average value of a balancer current.

(3) In the embodiment described above, the case is exemplified where, in a state where the energy storage apparatus 1 has been left, when the second condition is satisfied, a voltage of each energy storage cells 30A is discharged by the second reducing processing regardless of whether or not the voltage of each energy storage cell 30A is in a plateau region. However, in a case where voltages of all energy storage cells 30A are in a non-plateau region (a steep region), a difference in voltage between the respective energy storage cells 30A can be accurately measured to some extent. Accordingly, in a case where the second condition is satisfied, if the voltages of all energy storage cells 30A are in a non-plateau region, the voltages of the respective energy storage cells 30A may be measured, differences in voltage between the respective energy storage cells may be obtained, and balancer discharging electricity amounts of the respective energy storage cells 30A may be determined from the obtained differences in voltage. As a result, the differences in remaining electricity amount between the energy storage cells 30A are reduced. On the other hand, in a case where a voltage of any one of the energy storage cells 30A is in the plateau region, it is difficult to accurately measure a difference in voltage. Accordingly, in a case where a voltage of at least one energy storage cell 30A is in the plateau region, discharging may be performed by the second reducing processing described above. As a result, it is possible to reduce a difference in remaining electricity amount between the energy storage cells 30A in a case where the voltage of at least one energy storage cell 30A is in the plateau region.

(4) In the embodiment describe above, as an example, the case has been described where a balancer discharging history is recorded after the energy storage apparatus 1 is mounted on the vehicle. However, a test may be performed before the energy storage apparatus 1 is mounted on the vehicle, and a balancer discharging history may be stored in the storage unit 37B in advance.

(5) In the embodiment describe above, as an example, the case has been described where a difference in remaining electricity amount between the energy storage cells 30A is used as an example of a difference in electricity amount. Alternatively, assuming a difference between a full charging electricity amount (in other words, a remaining electricity amount at the time of full charging) of the energy storage cell 30A and a present remaining electricity amount of the energy storage cell 30A as a remaining chargeable electricity amount of the energy storage cell 30A, “a difference in electricity amount” may be a difference in remaining chargeable electricity amount between the energy storage cells 30A.

(6) In the embodiment, as an example, the case has been described where an arrival time until a difference in electricity amount between the energy storage cell 30A having the maximum remaining electricity amount and the energy storage cell 30A having the minimum remaining electricity amount reaches a predetermined maximum allowable value is predicted from a discharging history, and a difference in remaining electricity amount is reduced when the predicted arrival time has elapsed. On the other hand, the management unit 37 may perform estimation processing of sequentially estimating remaining electricity amounts of the energy storage cells 30A based on the discharging histories, and may reduce a difference in remaining electricity amount in a case where a difference in electricity amount between a maximum remaining electricity amount and a minimum remaining electricity amount with respect to remaining electricity amounts of the respective energy storage cells 30A estimated by the estimation processing reaches a predetermined maximum allowable value. With such a configuration, a difference in remaining electricity amount between the energy storage cells 30A when the energy storage apparatus 1 has been left can be suppressed to the maximum allowable value or less.

(7) In the embodiment described above, the description has been made by taking the energy storage apparatus 1 mounted on a vehicle such as an automobile as an example. However, the energy storage apparatus 1 is not limited to an energy storage apparatus mounted on a vehicle, and can be used for any arbitrary purposes.

(8) In the embodiment described above, the description has been made with respect to the case where the passive type balancer circuit 38 is used as an example of the balancer circuit 38. On the other hand, the balancer circuit 38 may be an active type balancer circuit 38 that reduces a difference in remaining electricity amount by charging the energy storage cell 30A having a low voltage with the energy storage cell 30A having a high voltage.

(9) In the embodiment described above, the case has been described where the lithium ion secondary battery has been used as an example of the energy storage cell 30A. However, the energy storage cell 30A may be a capacitor accompanied by an electrochemical reaction.

1. An energy storage apparatus comprising:
a plurality of energy storage cells;
a balancer circuit configured to allow each of the plurality of energy storage cells to individually perform discharging; and
a management unit, wherein
the management unit is configured to perform:
first reducing processing where a difference in an electricity amount between the energy storage cells is reduced by allowing at least one of the energy storage cells to perform discharging by the balancer circuit in a case where a voltage of any one of the energy storage cells is increased or a difference in voltage between any of the energy storage cells is increased so that a first condition of reducing the difference in the electricity amount between the energy storage cells is satisfied;
determination processing where it is determined whether a second condition of reducing the difference in the electricity amount between the energy storage cells is satisfied during a time period that the first condition is not satisfied;
second reducing processing where the difference in electricity amount between the energy storage cells is reduced by allowing at least one of the energy storage cells to perform discharging by the balancer circuit in a case where the second condition is satisfied; and
decision processing where a discharging electricity amount when the energy storage cell is discharged by the second reducing processing is decided based on a discharging history when the energy storage cell is discharged by at least the first reducing processing.

2. The energy storage apparatus according to claim 1, wherein the management unit is configured to perform prediction processing of predicting an arrival time until a difference in electricity amount between the energy storage cell having a maximum electricity amount and the energy storage cell having a minimum electricity amount reaches a predetermined value from a point of time that the energy storage cell is discharged by the balancer circuit based on the discharging history, and
the second condition is a condition that the arrival time has elapsed from a point of time that the energy storage cell is previously discharged by the balancer circuit.

3. The energy storage apparatus according to claim 2, wherein the management unit, in the decision processing, obtains a total value of discharging electricity amounts for each of predetermined time periods based on the discharging history for each of the energy storage cells, the total value of the discharge electricity amounts during the predetermined time period where a point of time at which the discharging is performed is newer is given larger weighting and the total values are averaged, thus obtaining weighting average of the total values of the discharge electricity amounts for each of the predetermined time periods, and discharging electricity amounts of the respective energy storage cells that are discharged by the second reducing processing are decided based on the weighting average of the total values of the discharge electricity amounts of the respective energy storage cells.

4. The energy storage apparatus according to claim 1, wherein, the second condition is a condition that an elapsed time period from a point of time that the energy storage cell is previously discharged by the balancer circuit reaches a predetermined time period.

5. The energy storage apparatus according to claim 1, wherein
the management unit performs estimation processing of sequentially estimating an electricity amount of each of the energy storage cells based on the discharging history, and
the second condition is a condition that a difference between a maximum electricity amount and a minimum electricity amount with respect to the electricity amount of each of the energy storage cells estimated by the estimation processing reaches a predetermined value.

6. The energy storage apparatus according to claim 1, wherein the energy storage cell has a plateau region where a change in voltage with respect to a change in charged state is small.

7. The energy storage apparatus according to claim 6, wherein the management unit is configured to perform the second reducing processing when the second condition is satisfied and a voltage of at least one of the energy storage cells is in the plateau region.

8. A method of controlling an energy storage apparatus that includes: a plurality of energy storage cells; and a balancer circuit configured to allow each of the plurality of energy storage cells to individually perform discharging, the method of controlling an energy storage apparatus comprising:
first reducing processing where, in a case where a voltage of any one of the energy storage cells is increased or a difference in voltage between any of the energy storage cells is increased so that a first condition of reducing a difference in electricity amount between the energy storage cells is satisfied, the difference in electricity amount between the energy storage cells is reduced by discharging at least one of the energy storage cells by the balancer circuit;
determination processing where it is determined whether a second condition of reducing the difference in the electricity amount between the energy storage cells is satisfied during a time period that the first condition is not satisfied;
second reducing processing where the difference in electricity amount between the energy storage cells is reduced by allowing at least one of the energy storage cell to perform discharging by the balancer circuit in a case where the second condition is satisfied; and
decision processing where a discharging electricity amount when the energy storage cell is discharged by the second reducing processing is decided based on a discharging history when the energy storage cell is discharged by at least the first reducing processing.
